(19) United States
(12) Patent Application Publication
(10) Pub. No.: US 2025/0283311 A1
(43) Pub. Date: Sep. 11, 2025

(54) FAUCET DEVICE

(71) Applicant: TOTO LTD., Kitakyushu-shi (JP)

(72) Inventors: Tsuyoshi Mieno, Fukuoka (JP); Kenichi Hashimoto, Fukuoka (JP)

(21) Appl. No.: 19/058,049

(22) Filed: Feb. 20, 2025

(30) Foreign Application Priority Data
Mar. 8, 2024 (JP) 2024-036270

(51) Int. Cl. E03C 1/04; E03C 1/02; G05D 7/06; G05D 11/16

(52) U.S. Cl. CPC E03C 1/0408; G05D 7/0652; G05D 11/16; E03C 2001/026; E03C 2001/0418

(57) ABSTRACT

A faucet device includes a water discharge part that discharges a hot or cold water and a faucet main body that is arranged inside a bathroom and supplies a hot or cold water to the water discharge part. The faucet main body includes a flow-rate/temperature control part that executes flow rate control and temperature control for a hot or cold water that is discharged from the water discharge part, a motor that drives the flow-rate/temperature control part, a controller that controls driving of the motor, a first waterproof case that houses the motor and isolates the motor from an internal space of the bathroom, and a second waterproof case that houses the controller and isolates the controller from an internal space of the bathroom. The first waterproof case and the second waterproof case are communicated with an external space of the bathroom.

### CROSS-REFERENCE TO RELATED APPLICATION(S)

This application is based upon and claims the benefit of priority to Japanese Patent Application No. 2024-036270, filed on Mar. 8, 2024, the entire contents of which are herein incorporated by reference.

### FIELD

A disclosed embodiment(s) relate(s) to a faucet device.

### BACKGROUND

A faucet device has conventionally been known where a motor that drives a temperature control part and a flow rate control part for a hot or cold water and a controller that controls driving of such a motor are housed in a waterproof case so as to be isolated from an external space of a bathroom (see, for example, Japanese Patent Application Publication No. H03-275822).

However, in a conventional faucet device as described above, dew condensation may occur inside a waterproof case that houses a motor and a controller. Furthermore, in a conventional faucet device as described above, a motor and a controller are housed in a single waterproof case, so that a size of such a waterproof case may be increased needlessly, so as to cause a size increase of a faucet main body.

### SUMMARY

According to an aspect of an embodiment, a faucet device includes a water discharge part that discharges a hot or cold water, and a faucet main body that is arranged inside a bathroom and supplies a hot or cold water to the water discharge part, wherein the faucet main body includes a flow-rate/temperature control part that executes flow rate control and temperature control for a hot or cold water that is discharged from the water discharge part, a motor that drives the flow-rate/temperature control part, a controller that controls driving of the motor, a first waterproof case that houses the motor and isolates the motor from an internal space of the bathroom, and a second waterproof case that houses the controller and isolates the controller from an internal space of the bathroom, and the first waterproof case and the second waterproof case are communicated with an external space of the bathroom.

### BRIEF DESCRIPTION OF DRAWING(S)

FIG. 1 is a diagram that illustrates an example of a bathroom unit where a faucet device according to an embodiment is arranged therein.

FIG. 2 is a front view that illustrates a remote controller.

FIG. 3 is a block diagram that illustrates an outline of a faucet device according to an embodiment.

FIG. 4 is a perspective view (part 1) that illustrates a faucet main body.

FIG. 5 is a perspective view that illustrates a water mixing faucet unit.

FIG. 6 is a front view that illustrates a water mixing faucet unit.

FIG. 7 is a perspective view thereof in a cross section along VII-VII in FIG. 6.

FIG. 8 is a perspective view (part 2) of a faucet main body.

FIG. 9 is a perspective view that illustrates a first waterproof case and a second waterproof case.

FIG. 10 is a perspective view that illustrates a variation of a first waterproof case and a second waterproof case.

FIG. 11 is a cross-sectional view that illustrates a binding member and a sealing member.

FIG. 12 is a perspective view that illustrates a binding member and a sealing member.

FIG. 13 is a perspective view that illustrates a cover member.

### DESCRIPTION OF EMBODIMENT(S)

Hereinafter, an embodiment(s) of a faucet device as disclosed in the present application will be explained in detail, with reference to the accompanying drawing(s). Additionally, this invention is not limited by an embodiment(s) as illustrated below.

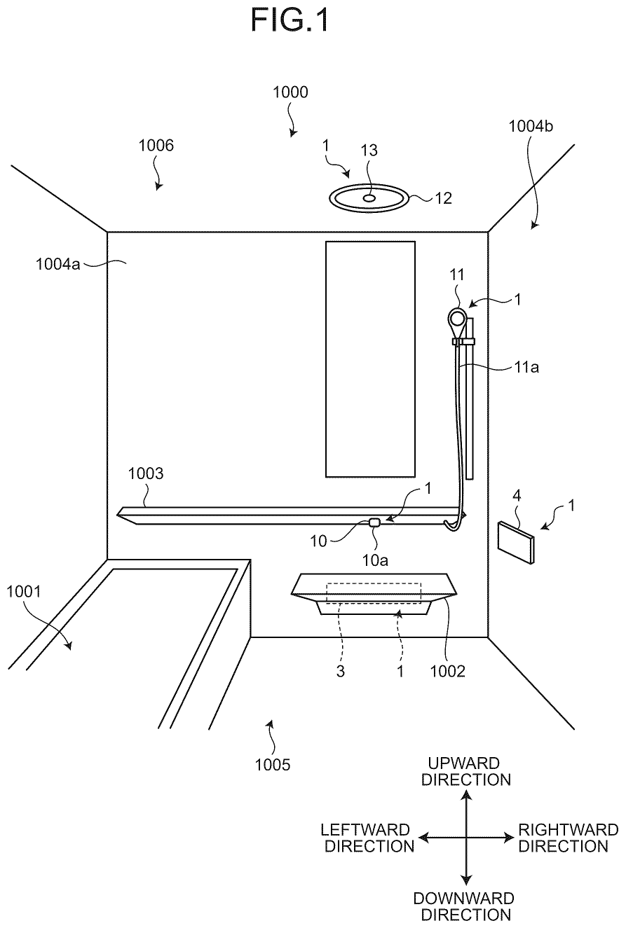

A faucet device 1 according to an embodiment is provided in, for example, a bathroom unit 1000 that is a bathroom, as illustrated in FIG. 1. FIG. 1 is a diagram that illustrates an example of a bathroom unit 1000 where a faucet device 1 according to an embodiment is arranged therein.

The bathroom unit 1000 includes a bathtub 1001, a first counter 1002, a second counter 1003, and the faucet device 1. Additionally, in a case where a cold water that is discharged by the faucet device 1 and a mixed water that is provided by mixing a hot water and a cold water and is discharged by the faucet device 1 are not distinguished, they will be referred to and explained as a “hot or cold water” below.

Hereinafter, an explanation may be provided by using frontward and backward directions where a direction of projecting of the second counter 1003 from a wall part 1004a of the bathroom unit 1000 is a frontward direction and an opposite side of such a frontward direction is a backward direction, and further, upward and downward directions where a vertical direction is a downward direction and an opposite side of such a downward direction is an upward direction. Furthermore, an explanation may be provided where directions that are orthogonal to frontward and backward directions and upward and downward directions are leftward and rightward directions.

The first counter 1002 is attached to the wall part 1004a of the bathroom unit 1000. The first counter 1002 projects from the wall part 1004a to an inside of a bathroom. The first counter 1002 is provided on an upper side of a washing place floor 1005 of the bathroom unit 1000. The first counter 1002 houses a faucet main body 3 of the faucet device 1.

The second counter 1003 is attached to the wall part 1004a. The second counter 1003 projects from the wall part 1004a to an inside of a bathroom. The second counter 1003 is provided on an upper side of the first counter 1002. For example, the second counter 1003 is provided so as to extend to an upper side of the bathtub 1001. Additionally, the second counter 1003 does not have to extend to an upper side of the bathtub 1001.

The second counter 1003 houses a part of the faucet device 1. Specifically, the second counter 1003 houses a part of a water tap 10 of the faucet device 1 and a part of a hand shower 11 of the faucet device 1. The second counter 1003 is provided so as to expose a water discharge port 10a of the water tap 10. The water discharge port 10a of the water tap 10 is provided on the second counter 1003 in such a manner that a direction of discharging of a hot or cold water is a downward direction.

Furthermore, the second counter 1003 is connected to a shower hose 11a of the hand shower 11 of the faucet device 1. The shower hose 11a is connected to a shower water conduit that is housed in the second counter 1003.

An overhead shower 12 of the faucet device 1 and a warm pillar 13 of the faucet device 1 are attached to a ceiling 1006 of the bathroom unit 1000. The overhead shower 12 and the warm pillar 13 are provided integrally.

The overhead shower 12 discharges a hot or cold water to an area of a user that is greater than that for the hand shower 11. For example, the overhead shower 12 is configured to apply a hot or cold water to a whole body of a user. The warm pillar 13 integrates a hot or cold water into, directs a flow of, and discharges a single stream of water. In other words, the warm pillar 13 directs a flow of, and discharges, a hot or cold water in such a manner that an uninterrupted hot or cold water flows down like a pillar.

A remote controller 4 (an operation part) of the faucet device 1 is attached to a wall part 1004b of the bathroom unit 1000. The remote controller 4 may be attached to the wall part 1004a where the first counter 1002 and the second counter 1003 are attached thereto.

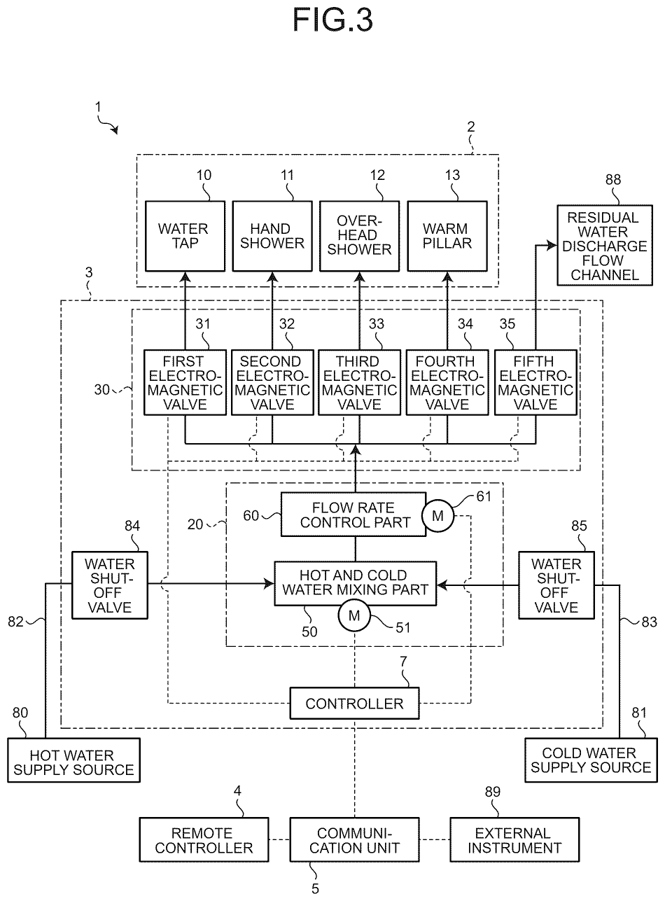

The remote controller 4 receives various types of operations of a user for the faucet main body 3. Specifically, the remote controller 4 receives a setting operation for a temperature of a hot or cold water on the faucet main body 3. The remote controller 4 receives a setting operation for a flow rate of a hot or cold water on the faucet main body 3. The remote controller 4 receives a switching operation for discharging and stopping of a hot or cold water. The remote controller 4 receives a switching operation for a discharging place of a hot or cold water. In a case where the remote controller 4 is operated by a user, it transmits an operation signal that corresponds to each operation to a controller 7 (see FIG. 3) of the faucet device 1.

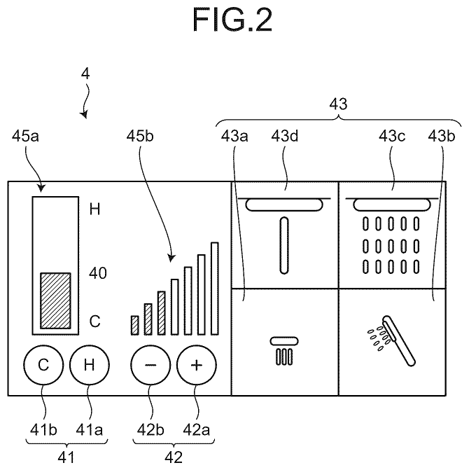

The remote controller 4 includes, for example, a temperature control button 41, a water flow rate control button 42, and a switching button 43, as illustrated in FIG. 2. FIG. 2 is a front view that illustrates a remote controller 4.

The temperature control button 41 is a button for controlling a temperature of a mixed water in a faucet main body 3. The temperature control button 41 includes a high temperature button 41a and a low temperature button 41b. The high temperature button 41a is a button for raising a temperature of a mixed water. The low temperature button 41b is a button for lowering a temperature of a mixed water. Additionally, the remote controller 4 displays a setting state for a temperature of a mixed water on a first display part 45a. In a case where the high temperature button 41a or the low temperature button 41b is operated, a display of the first display part 45a is changed depending on an operation of each button 41a, 41b.

Additionally, a temperature of a mixes water in the faucet main body 3 is controllable within a predetermined temperature range. In a case where the low temperature button 41b is operated in such a manner that a set temperature of a mixed water is lower than a minimum temperature within a predetermined temperature range, a hot water is not mixed into a cold water in the faucet main body 3, so that such a cold water is discharged.

The water flow rate control button 42 is a button for controlling a flow rate of a hot or cold water that is discharged from a faucet device 1. The water flow rate control button 42 includes a water increasing button 42a and a water decreasing button 42b. The water increasing button 42a is a button for increasing a flow rate of a hot or cold water. The water decreasing button 42b is a button for decreasing a flow rate of a hot or cold water. Additionally, the remote controller 4 displays a setting state for a water flow rate of a hot or cold water on a second display part 45b. In a case where the water increasing button 42a or the water decreasing button 42b is operated, a display of the second display part 45b is changed depending on an operation of each button 42a, 42b. Additionally, a flow rate of a hot or cold water that is discharged from the faucet device 1 is controllable within a predetermined flow rate range.

The switching button 43 is a button for switching between discharging and stopping of a hot or cold water in the faucet device 1. Furthermore, the switching button 43 is a button for switching a discharging place of a hot or cold water in the faucet device 1. The switching button 43 includes a water tap button 43a, a hand shower button 43b, an overhead shower button 43c, and a warm pillar button 43d. Each of buttons 43a to 43d is pushed by a user, so as to be switched between “ON” and “OFF”.

In a case where each of buttons 43a to 43d of the switching button 43 is “OFF”, no hot or cold water is discharged. That is, the faucet device 1 is provided in a water stopping state thereof.

In a case where one switching button 43 is pushed from a state where each of buttons 43a to 43d of the switching button 43 is “OFF” and thereby a pushed switching button 43 is turned to “ON”, a hot or cold water is discharged. That is, the faucet device 1 is turned from a water stopping state to a water discharging state thereof.

In a case where another switching button 43 is pushed in a state where one switching button 43 is “ON”, a switching button 43 that is “ON” is changed, so that a discharging place of a hot or cold water is switched.

For example, in a case where the hand shower button 43b is “ON”, a hot or cold water is discharged from a hand shower 11. In a case where the water tap button 43a is pushed in such a state, the hand shower button 43b is turned to “OFF” and the water tap button 43a is turned to “ON”. Thereby, a discharging place of a hot or cold water is changed from the hand shower 11 to a water tap 10, so that such a hot or cold water is discharged from the water tap 10.

In a case where a switching button 43 that is “ON” is pushed again, such a pushed switching button 43 is turned to “OFF”, so that each of buttons 43a to 43d of the switching button 43 is “OFF” and a hot or cold water is stopped. That is, the faucet device 1 is turned from a water discharging state to a water stopping state thereof.

Additionally, each of the buttons 43a to 43d is configured in such a manner that it is possible for a user to recognize “ON” and “OFF” states thereof. For example, a switching button 43 that is “ON” is turned on and a switching button 43 that is “OFF” is turned off.

Additionally, although the faucet device 1 that is allowed to discharge a hot or cold water from an overhead shower 12, a warm pillar 13, the hand shower 11, and the water tap 10 has been explained as an example herein, this is not limitative. For example, the faucet device 1 may be configured to have none of the overhead shower 12 and the warm pillar 13.

Next, an outline of a faucet device 1 according to an embodiment will be explained with reference to FIG. 3. FIG. 3 is a block diagram that illustrates an outline of a faucet device 1 according to an embodiment. In FIG. 3, a flow of a hot or cold water is indicated by an arrow of a solid line and a communication line is indicated by a broken line.

The faucet device 1 includes a plurality of water discharge parts 2, a faucet main body 3, a remote controller 4, and a communication unit 5.

The plurality of water discharge parts 2 include a water tap 10, a hand shower 11, an overhead shower 12, and a warm pillar 13.

The faucet main body 3 includes a water mixing faucet unit 20, a water discharge switching part 30, and a controller 7.

The water mixing faucet unit 20 includes a flow-rate/temperature control part(s) that execute(s) flow rate control and temperature control for a hot or cold water that is discharged from a water discharge part(s) 2. The water mixing faucet unit 20 includes a hot and cold water mixing part 50 that is a temperature control part for a hot or cold water, and a flow rate control part 60, as flow-rate/temperature control parts. A hot water is supplied from a hot water supply source 80 to the hot and cold water mixing part 50. Furthermore, a cold water is supplied from a cold water supply source 81 to the hot and cold water mixing part 50. A water shut-off valve 84 is provided in a flow channel (a hot water supply pipe 82) between the hot and cold water mixing part 50 and the hot water supply source 80. Furthermore, a water shut-off valve 85 is provided in a flow channel (a cold water supply pipe 83) between the hot and cold water mixing part 50 and the cold water supply source 81.

The hot and cold water mixing part 50 mixes a hot water that is supplied from the hot water supply source 80 and a cold water that is supplied from the cold water supply source 81. Specifically, the hot and cold water mixing part 50 switches as to whether or not a hot water is mixed into a cold water. Furthermore, the hot and cold water mixing part 50 controls a rate of a hot water that is mixed into a cold water so as to control a temperature of a mixed water.

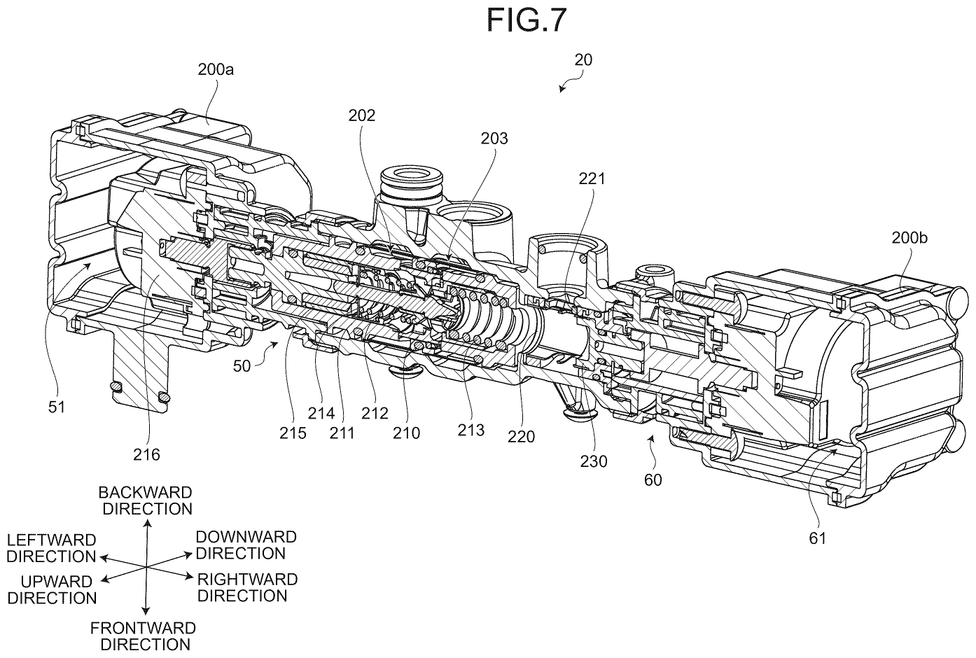

The water mixing faucet unit 20 includes a motor that drives a flow-rate/temperature control part(s). In the present embodiment, the hot and cold water mixing part 50 includes a first motor 51. The first motor 51 is, for example, a stepping motor. The first motor 51 is driven depending on an operation of a temperature control button 41 of the remote controller 4, so that the hot and cold water mixing part 50 drives a temperature control valve 210 (see FIG. 7) so as to switch as to whether or not a hot water is mixed into a cold water.

Furthermore, the first motor 51 is driven depending on an operation of the temperature control button 41 of the remote controller 4, so that the hot and cold water mixing part 50 drives the temperature control valve 210 so as to control a proportion of a hot water that is mixed into a cold water. Furthermore, even in a case where no operation of the temperature control button 41 is executed, for example, as a temperature of a hot water is changed so as to change a temperature of a mixed water, the hot and cold water mixing part 50 controls a ratio of a flow rate of a hot water to a flow rate of a cold water depending on such a temperature of a mixed water, so that it is possible to control such a temperature of a mixed water automatically.

A hot or cold water flows from the hot and cold water mixing part 50 into the flow rate control part 60. In a case where a hot or cold water is discharged from a water discharge part(s) 2, the flow rate control part 60 controls a flow rate of a discharged hot or cold water.

As described above, the water mixing faucet unit 20 includes a motor that drives a flow-rate/temperature control part(s). In the present embodiment, the flow rate control part 60 includes a second motor 61. The second motor 61 is, for example, a stepping motor. The second motor 61 is driven depending on a water flow rate control button 42 of the remote controller 4, so that the flow rate control part 60 drives a flow control valve 230 (see FIG. 7) so as to control a flow rate of a hot or cold water.

The water discharge switching part 30 switches discharging or stopping of a hot water or cold water that flows out of the water mixing faucet unit 20. That is, the water discharge switching part 30 switches discharging or stopping of a hot or cold water from a water discharge part(s) 2. Furthermore, the water discharge switching part 30 switches a discharging place of a hot or cold water. In the faucet device 1, switching of discharging or stopping of a hot or cold water from a water discharge part(s) 2 is executed by the water discharge switching part 30 and control of a flow rate of such a hot or cold water in a case where such a hot or cold water is discharged is executed by the flow rate control part 60.

The water discharge switching part 30 includes a plurality of electromagnetic valves 31 to 35. Specifically, the water discharge switching part 30 includes a first electromagnetic valve 31, a second electromagnetic valve 32, a third electromagnetic valve 33, and a fourth electromagnetic valve 34. The water discharge switching part 30 may include a fifth electromagnetic valve 35.

The first electromagnetic valve 31 to the fourth electromagnetic valve 34 are switched to “closed (OFF)” or “open (ON)” depending on an operation of a switching button 43.

In a case where the first electromagnetic valve 31 to the fourth electromagnetic valve 34 are “closed”, no hot or cold water is discharged from a water discharge part(s) 2. That is, in a case where the first electromagnetic valve 31 to the fourth electromagnetic valve 34 are “closed”, a hot or cold water is stopped. In a case where one of the first electromagnetic valve 31 to the fourth electromagnetic valve 34 is “open”, a hot or cold water is discharged from a water discharge part 2 that corresponds to an electromagnetic valve that is “open”.

The first electromagnetic valve 31 switches discharging or stopping of a hot or cold water in the water tap 10. The second electromagnetic valve 32 switches discharging or stopping of a hot or cold water in the hand shower 11. The third electromagnetic valve 33 switches discharging or stopping of a hot or cold water in the overhead shower 12. The fourth electromagnetic valve 34 switches discharging or stopping of a hot or cold water in the warm pillar 13.

For example, in a case where the first electromagnetic valve 31 is “open” and the second electromagnetic valve 32 to the fourth electromagnetic valve 34 are “closed”, a hot or cold water is discharged from the water tap 10.

The fifth electromagnetic valve 35 is switched to “closed (OFF)” or “open (ON)” depending on an operation that is executed by an external instrument 89 (for example, a multiple remote controller that is provided in a wash room). Additionally, the fifth electromagnetic valve 35 may be switched to “closed” or “open” depending on an operation of the remote controller 4. The fifth electromagnetic valve 35 is a valve for draining a residual water in a hose and/or a pipe of the hand shower 11, etc., and is normally maintained at “closed”. That is, the fifth electromagnetic valve 35 is turned to “closed” only in a case where a residual water process is executed. In a case where the fifth electromagnetic valve 35 is turned to “open”, a residual water is drained from a residual water discharge flow channel 88.

The controller 7 controls the first motor 51, the second motor 61, and the first electromagnetic valve 31 to the fourth electromagnetic valve 34, depending on an operation of the faucet main body 3 that is received by an operation of the remote controller 4. Furthermore, the controller 7 controls the fifth electromagnetic valve 35 depending on, for example, an operation of the external instrument 89.

The controller 7 includes, for example, a microcomputer that has a Central Processing Unit (CPU), a Read Only Memory (ROM), a Random Access Memory (RAM), etc., and/or various types of circuits. Additionally, the controller 7 may include hardware such as an Application Specific Integrated Circuit (ASIC) and/or a Field Programmable Gate Array (FPGA).

The communication unit 5 receives an operation signal(s) from the remote controller 4 and the external instrument 89 and transmits a received operation signal(s) to the controller 7. The remote controller 4 and the external instrument 89 are connected to the communication unit 5 by wired communication or wireless communication. The controller 7 is connected to the communication unit 5 by wired communication or wireless communication.

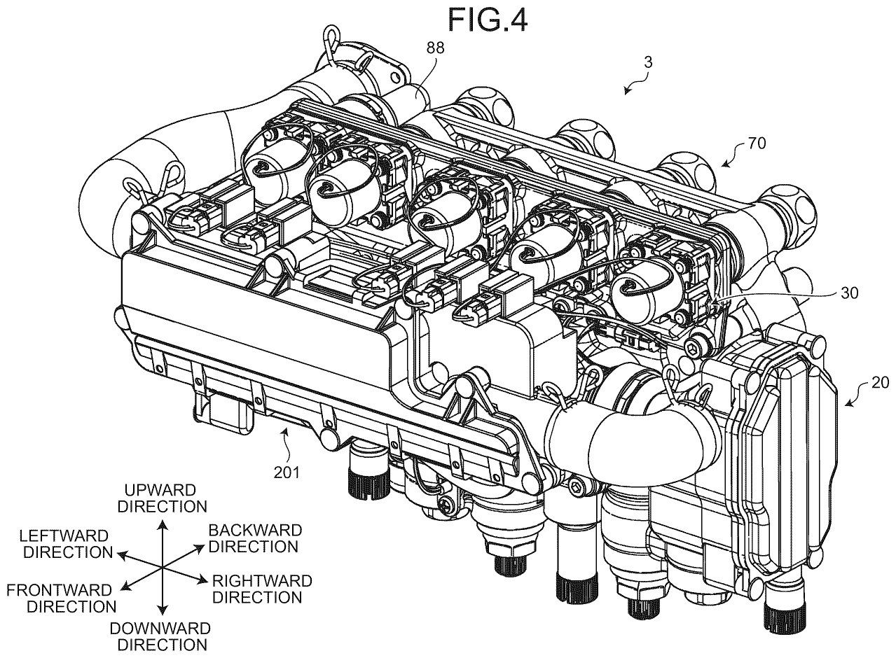

Next, a faucet main body 3 will be explained with reference to FIG. 4. FIG. 4 is a perspective view that illustrates a faucet main body 3. The faucet main body 3 includes a flow channel unit 70 in addition to a water mixing faucet unit 20, a water discharge switching part 30, and a controller 7 (see FIG. 3). The faucet main body 3 is attached to a wall part 1004a of a bathroom unit 1000 (see FIG. 1) by the flow channel unit 70.

A flow channel where a hot water that is supplied from a hot water supply source 80 (see FIG. 3) flows into the water mixing faucet unit 20, a flow channel where a cold water that is supplied from a cold water supply source 81 (see FIG. 3) flows into the water mixing faucet unit 20, and a flow channel where a hot or cold water flows from the water mixing faucet unit 20 into each water discharge part 2 are formed in the flow channel unit 70. Additionally, the water discharge switching part 30 is provided in the flow channel unit 70. Furthermore, water shut-off valves 84, 85 (see FIG. 3) are provided in the flow channel unit 70. Furthermore, a residual water discharge flow channel 88 is provided in the flow channel unit 70.

In the faucet main body 3, the flow channel unit 70 is provided at a back side thereof and the water mixing faucet unit 20 is provided at a front side of the flow channel unit 70. Additionally, a part of the flow channel unit 70 is provided at an upper side of the water mixing faucet unit 20. Furthermore, a controller case 201 that is a second waterproof case as described later and houses the controller 7 at a front side of the water mixing faucet unit 20 is provided therein.

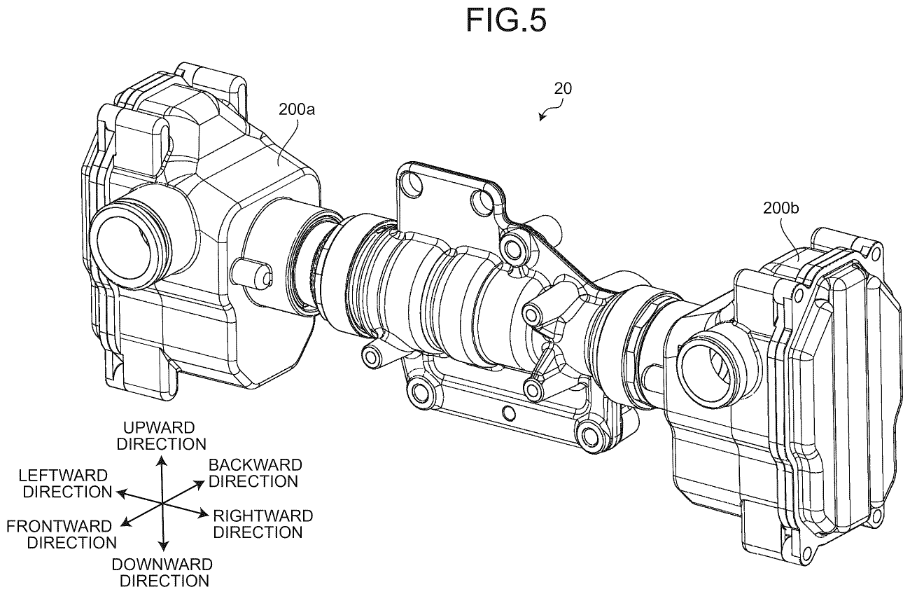

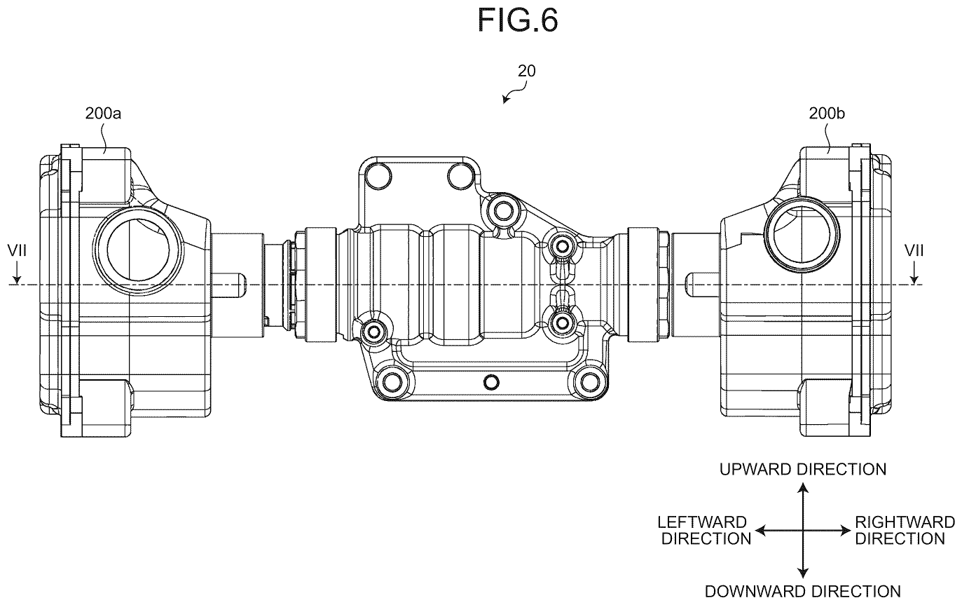

Next, a water mixing faucet unit 20 will be explained with reference to FIG. 5 to FIG. 7. FIG. 5 is a perspective view that illustrates a water mixing faucet unit 20. FIG. 6 is a front view that illustrates a water mixing faucet unit 20. FIG. 7 is a perspective view in a cross section along VII-VII in FIG. 6.

The water mixing faucet unit 20 is provided so as to extend in leftward and rightward directions. A first motor case 200a that is a first waterproof case as described later and houses a first motor 51 of a hot and cold water mixing part 50 is provided at one end of the water mixing faucet unit 20 in leftward and rightward directions, specifically, a left end thereof. A second motor case 200b that is a first waterproof case as described later and houses a second motor 61 of a flow rate control part 60 is provided at another end of the water mixing faucet unit 20 in leftward and rightward directions, specifically, a right end thereof.

The hot and cold water mixing part 50 moves a temperature control valve 210 (a control valve) in leftward and rightward directions so as to switch as to whether or not a hot water that is supplied from a hot water supply channel 203 is mixed into a cold water that is supplied from a cold water supply channel 202.

For example, the temperature control valve 210 contacts a case 211 that is provided at a left side of the temperature control valve 210, so that supply of a hot water is shut off by the temperature control valve 210 and thereby such a hot water is not mixed into a cold water that is supplied from the cold water supply channel 202.

Furthermore, the temperature control valve 210 is separated from the case 211 and thereby supply of a hot water is not shut off by the temperature control valve 210, so that a hot water that is supplied from the hot water supply channel 203 is mixed into a cold water that is supplied from the cold water supply channel 202.

The temperature control valve 210 is pressed by a temperature-sensitive spring 212 in a direction where it is separated from the case 211. Furthermore, the temperature control valve 210 is pressed by a bias spring 213 in a direction where it contacts the case 211. That is, the temperature control valve 210 is moved in leftward and rightward directions according to a magnitude relationship between a pressing force of the temperature-sensitive spring 212 and a pressing force of the bias spring 213.

The temperature-sensitive spring 212 is a spring with a spring constant that is changed depending on a temperature thereof and is composed of, for example, a shape memory alloy. The bias spring 213 is a spring with a spring constant that is nearly constant with respect to a temperature thereof.

In a case where a pressing force of the bias spring 213 is greater than a pressing force of the temperature-sensitive spring 212, the temperature control valve 210 is moved toward a left side that is a side of the case 211. Additionally, in a case where the temperature control valve 210 contacts the case 211, the temperature control valve 210 is held in a state where it contacts the case 211.

In a case where a pressing force of the temperature-sensitive spring 212 is greater than a pressing force of the bias spring 213, the temperature control valve 210 is moved toward a right side in such a manner that it is separated from the case 211.

In a case where a pressing force of the temperature-sensitive spring 212 and a pressing force of the bias spring 213 are equal, the temperature control valve 210 is not moved in a leftward or rightward direction and is held at a position where such a pressing force of the temperature-sensitive spring 212 and such a pressing force of the bias spring 213 are balanced.

The temperature-sensitive spring 212 contacts a liner 214 at another end that is an opposite side of one end that contacts the temperature control valve 210. The liner 214 is connected to a rotational shaft part 216 through a spindle 215. The spindle 215 is supported by the case 211 so as to be rotatable and converts a rotational movement of the rotational shaft part 216 to a translatory movement of the liner 214 in leftward and rightward directions. Hence, the liner 214 is moved in leftward and rightward directions depending on rotation of the rotational shaft part 216.

The rotational shaft part 216 is connected to the first motor 51 through a transmission mechanism. A transmission mechanism is housed in the first motor case 200a. A transmission mechanism includes a first gear that is connected to a rotational shaft of the first motor 51 and a second gear that is connected to the rotational shaft part 216. A first gear and A second gear are engaged with one another. Rotation of a rotational shaft of the first motor 51 is transmitted to the rotational shaft part 216 through a transmission mechanism. Additionally, such a transmission mechanism is similar to a transmission mechanism in the flow rate control part 60 as described later.

In the hot and cold water mixing part 50, the liner 214 is moved in leftward and rightward directions according to a rotational position of the rotational shaft part 216, that is, a rotational position of a rotational shaft of the first motor 51. That is, it is possible for the hot and cold water mixing part 50 to change a position of the temperature control valve 210 at a position where a pressing force of the temperature-sensitive spring 212 and a pressing force of the bias spring 213 are balanced, according to a rotational position of a rotational shaft of the first motor 51. Thereby, it is possible for the hot and cold water mixing part 50 to cause a temperature of a mixed water to be a set temperature that corresponds to a rotational position of a rotational shaft of the first motor 51, in a case where such a mixed water is discharged.

Furthermore, in a case where a mixed water is discharged, for example, as a temperature of a hot water is changed so as to change a temperature of such a mixed water, the temperature-sensitive spring 212 is expanded or compressed depending on a temperature of such a mixed water and thereby the temperature control valve 210 is moved in leftward and rightward directions, so that a balanced position of the temperature control valve 210 is changed automatically. Thereby, an amount of a hot water and an amount of a cold water in a mixed water is controlled, so that a temperature of such a mixed water is controlled automatically.

The hot and cold water mixing part 50 is communicated with the flow rate control part 60 through a communication hole 220. A hot or cold water flows from the hot and cold water mixing part 50 into the flow rate control part 60 through the communication hole 220.

The flow rate control part 60 rotates a flow control valve 230 (a control valve) around a virtual axis that extends in leftward and rightward directions, as a center thereof, so as to change an area where an opening of the flow control valve 230 is communicated with an opening of a control member 221 and thereby change an opening degree of the flow control valve 230. The flow rate control part 60 changes an opening degree of the flow control valve 230 so as to control a flow rate of a hot or cold water that flows out of the water mixing faucet unit 20, that is, a flow rate of a hot or cold water that is discharged from a water discharge part(s) 2 (see FIG. 3).

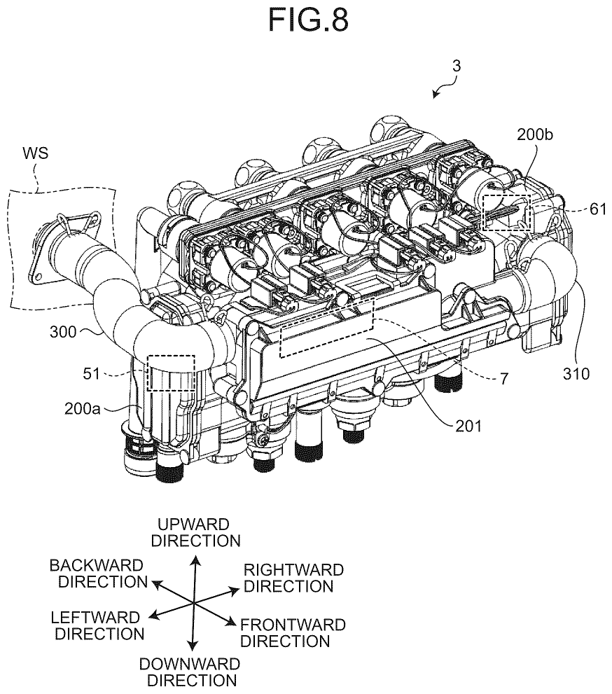

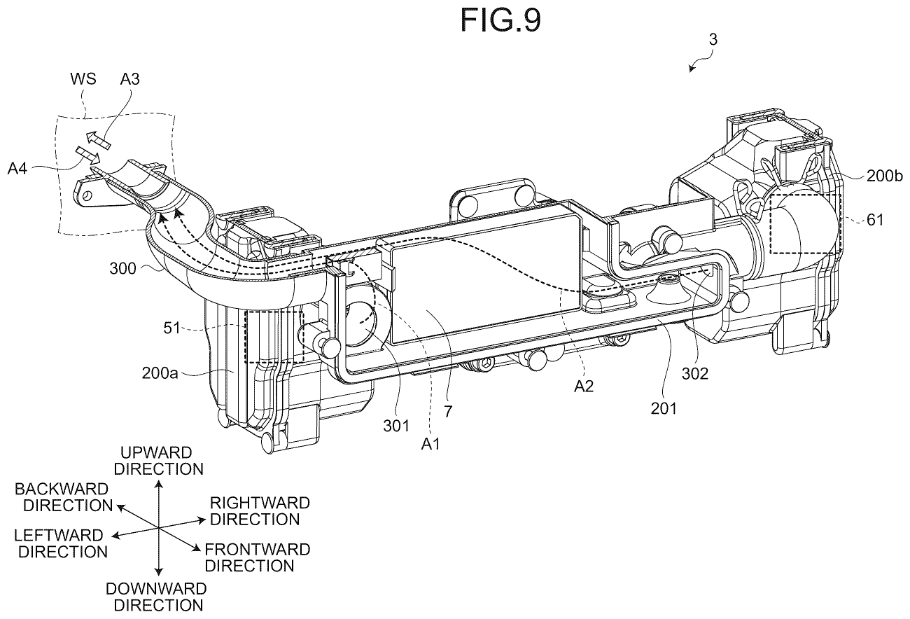

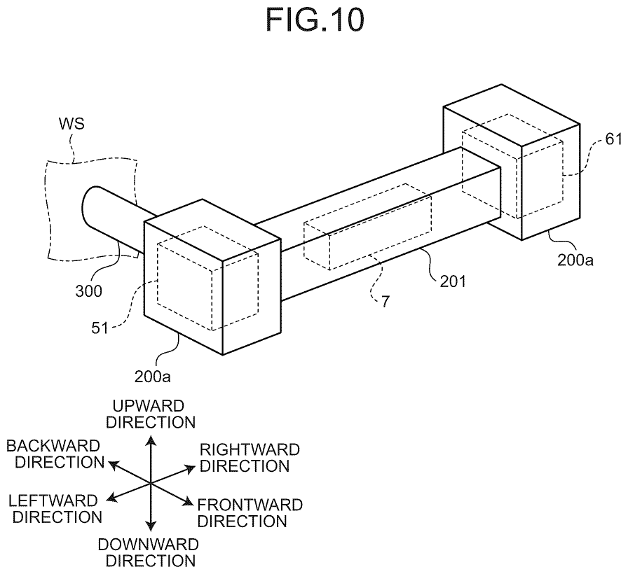

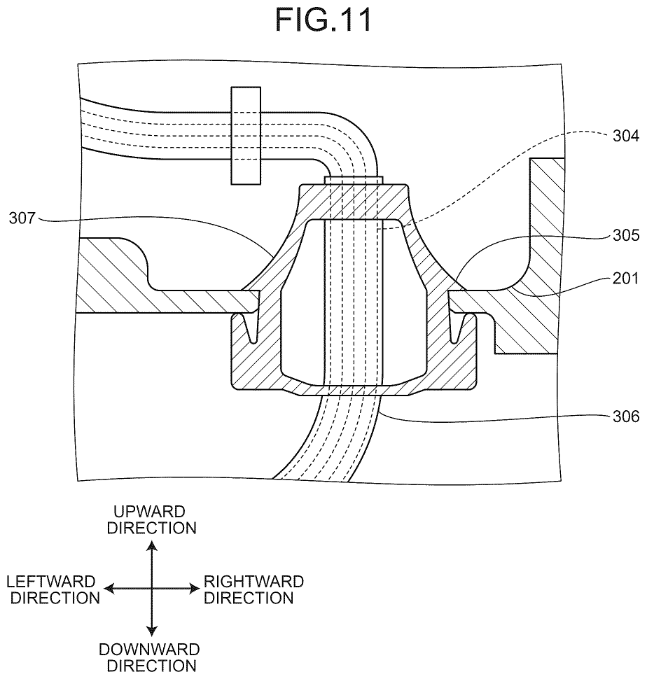

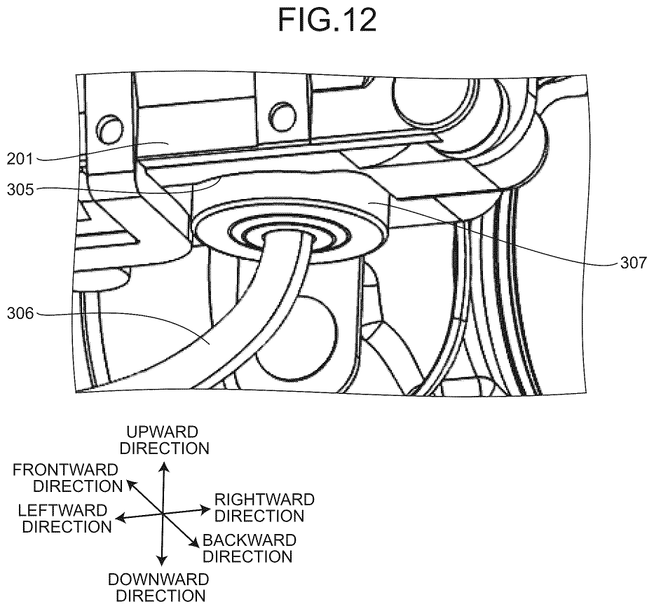

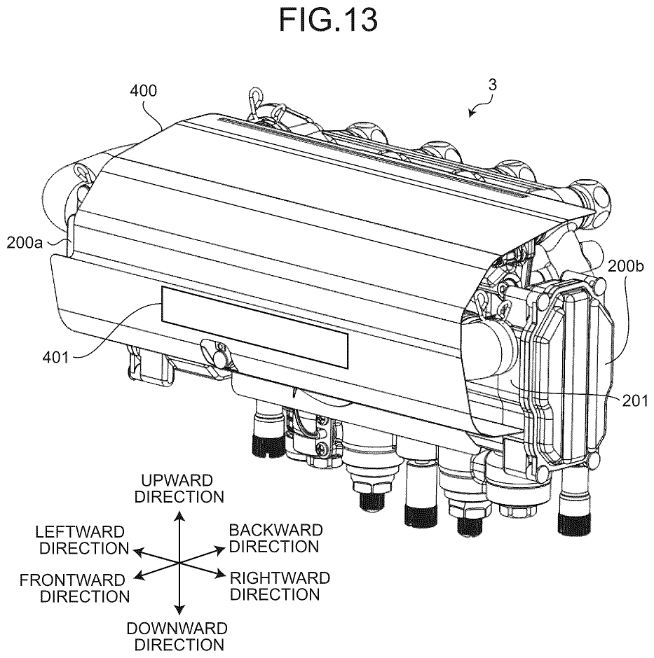

Next, a faucet main body 3 will further be explained with reference to FIGS. 8 to 13. FIG. 8 is a perspective view of a faucet main body 3. FIG. 9 is a perspective view that illustrates first waterproof cases 200a, 200b and a second waterproof case 201. FIG. 10 is a perspective view that illustrates a variation of first waterproof cases 200a, 200b and a second waterproof case 201. FIG. 11 is a cross-sectional view that illustrates a binding member 306 and a sealing member 307. FIG. 12 is a perspective view that illustrates a binding member 306 and a sealing member 307. FIG. 13 is a perspective view that illustrates a cover member 400.

As described above, the faucet main body 3 is arranged inside a bathroom unit 1000 (see FIG. 1). As illustrated in FIG. 8, in the faucet main body 3, a first motor 51 that drives a hot and cold water mixing part 50 is housed in a first motor case 200a that is a first waterproof case. In the faucet main body 3, a second motor 61 that drives a flow rate control part 60 is housed in a second motor case 200b that is a first waterproof case. That is, a first waterproof case(s) include(s) the first motor case 200a and the second motor case 200b.

As illustrated in FIG. 9, the first motor case 200a houses the first motor 51 so as to isolate the first motor 51 from an internal space of the bathroom unit 1000. The second motor case 200b houses the second motor 61 so as to isolate the second motor 61 from an internal space of the bathroom unit 1000. Thus, the first motor case 200a and the second motor case 200b that are first waterproof cases house the first motor 51 and the second motor 61 separately.

Furthermore, in the faucet main body 3, a controller 7 is housed in the controller case 201 that is a second waterproof case. The controller case 201 houses the controller 7 so as to isolate the controller 7 from an internal space of the bathroom unit 1000.

One waterproof case among the first motor case 200a and the second motor case 200b that are first waterproof cases and the controller case 201 that is a second waterproof case is communicated with an external space of the bathroom unit 1000.

Furthermore, another waterproof case among the first motor case 200a and the second motor case 200b that are first waterproof cases and the controller case 201 that is a second waterproof case is communicated with one waterproof case that is communicated with an external space of the bathroom unit 1000.

In an example as illustrated in FIG. 9, the controller case 201 that is a second waterproof case is communicated with an external space of the bathroom unit 1000 and the first motor case 200a and the second motor case 200b that are first waterproof cases are communicated with the controller case 201. The first motor 51 is arranged closer to a part that is communicated with an external space of the bathroom unit 1000 than the second motor 61.

By returning to FIG. 8, one waterproof case among the first motor case 200a and the second motor case 200b that are first waterproof cases and the controller case 201 that is a second waterproof case is communicated with an external space of the bathroom unit 1000. In such a case, one waterproof case is communicated with an external space of the bathroom unit 1000 through a hose member 300.

The hose member 300 has flexibility. One end part of the hose member 300 is connected to the faucet main body 3 and another end part thereof is connected to a wall (a wall surface WS) of the bathroom unit 1000. One waterproof case among the first motor case 200a and the second motor case 200b that are first waterproof cases and the controller case 201 that is a second waterproof case (for example, the controller case 201 that is a second waterproof case) is communicated with a space behind a wall of the bathroom unit 1000.

As illustrated in FIG. 9, in a case where an air inside a waterproof case flows out to an external space of the bathroom unit 1000, an air Al from the first motor case 200a as a first waterproof case flows through the hose member 300 from a communication hole 301 toward a wall surface WS through the controller case 201 that is a second waterproof case. Additionally, the communication hole 301 is a hole for communicating between the first motor case 200a as a first waterproof case and the controller case 201 that is a second waterproof case.

Furthermore, in a case where an air inside a waterproof case flows out to an external space of the bathroom unit 1000, an air A2 from the second motor case 200b as a first waterproof case flows out from a communication hole 302 to the hose member 300 toward a wall surface WS through the controller case 201 that is a second waterproof case. Additionally, the communication hole 302 is a hole for communicating between the second motor case 200b as a first waterproof case and the controller case 201 that is a second waterproof case.

An air A3 that is provided by combining an air A1 from the first motor case 200a and an air A2 from the second motor case 200b flows out from the hose member 300 to an external space of the bathroom unit 1000.

Furthermore, in a case where an air flows from an external space of the bathroom unit 1000 into an inside of a waterproof case, an air A4 from such an external space of the bathroom unit 1000 flows into the hose member 300, and flows out from the hose member 300 to the first motor case 200a and the second motor case 200b that are first waterproof cases through the controller case 201 that is a second waterproof case.

In such a configuration, the first waterproof cases 200a, 200b and the second waterproof case 201 are communicated with an external space of the bathroom unit 1000 such as a space behind a wall thereof, so that an air A4 outside the bathroom unit 1000 flows into the first waterproof case 200a and the second waterproof case 201 and an air A3 flows out from the first waterproof cases 200a, 200b and the second waterproof case 201 to an outside of the bathroom unit 1000. An air A4 outside the bathroom unit 1000 moves in and out of the first waterproof cases 200a, 200b and the second waterproof case 201, so that it is possible to cause the first waterproof cases 200a, 200b and the second waterproof case 201 to execute so-called “breathing”. Thus, the first waterproof cases 200a, 200b and the second waterproof case 201 execute “breathing”, so that it is possible to cause a temperature inside the first waterproof cases 200a, 200b and the second waterproof case 201 to be identical to be a temperature outside the bathroom unit 1000. Thereby, it is possible to reduce or prevent occurrence of dew condensation inside the first waterproof cases 200a, 200b and the second waterproof case 201. Furthermore, the motors 51, 61 are covered by the first waterproof cases 200a, 200b and the controller 7 is covered by the second waterproof case 201, that is, the motors 51, 61 and the controller 7 are covered by waterproof cases separately, so that it is possible to minimize sizes of respective waterproof cases. Thereby, it is possible to reduce or prevent a size increase of the faucet main body 3.

Furthermore, one of the first waterproof cases 200a, 200b and the second waterproof case 201 is communicated with an external space of the bathroom unit 1000 and another thereof is communicated with the one, so that another waterproof case is indirectly communicated with such an external space of the bathroom unit 1000 through one waterproof case. Thereby, it is possible to reduce a number of a hole(s) that is/are formed on a wall of the bathroom unit 1000, etc., in order to communicate a waterproof case with an external space of the bathroom unit 1000, so that it is possible to increase a degree of freedom of arrangement of the motors 51, 61 and the controller 7. Thereby, it is possible to reduce or prevent a size increase of the faucet main body 3. Furthermore, in a case where areas of holes that are formed on a wall of the bathroom unit 1000, etc., are identical, an efficiency of air ventilation is increased for a single large hole rather than for a plurality of small holes, so that it is possible to reduce or prevent occurrence of dew condensation effectively. Furthermore, a single large hole is provided, so that only single connection is needed as compared with a case where a plurality of small holes are connected separately, and thereby, manufacturability and workability thereof are improved.

Furthermore, the first waterproof cases 200a, 200b house the first motor 51 and the second motor 61 separately, the second waterproof case 201 is communicated with an external space of the bathroom unit 1000, and further the first motor 51 is arranged closer to a part that is communicated with such an external space of the bathroom unit 1000 than the second motor 61, so that even in a case where the first waterproof cases 200a, 200b that house the motors 51, 61 are indirectly communicated with such an external space of the bathroom unit 1000, it is possible to arrange the first motor 51 for temperature control for a hot or cold water that causes dew condensation more readily than the second motor 61 for flow rate control, closer to a part that is communicated with such an external space of the bathroom unit 1000 such as a wall of the bathroom unit 1000. Thereby, it is possible to reduce or prevent occurrence of dew condensation effectively. Furthermore, replacement of the first motor 51 is also facilitated.

Furthermore, a waterproof case that is communicated with an external space of the bathroom unit 1000 among the first waterproof cases 200a, 200b and the second waterproof case 201 is communicated with such an external space of the bathroom unit 1000 through the hose member 300, so that a degree of freedom of arrangement of the motors 51, 61 and the controller 7 is increased. In particular, the hose member 300 has flexibility that allows to be bent freely to certain extent, so that a degree of freedom of arrangement of a waterproof case(s) is increased. Furthermore, the hose member 300 has flexibility, so that it is possible to ensure watertightness without applying a force to a waterproof case(s).

Furthermore, by returning to FIG. 8, the second motor case 200b that houses the second motor 61 is connected to the controller case 201 that is a second waterproof case and houses the controller 7 by a hose member 310. The second motor case 200b is communicated with an external space of the bathroom unit 1000, that is, a space behind a wall of the bathroom unit 1000, through the hose member 300, the controller case 201, and the hose member 310.

The hose member 310 has flexibility like the hose member 300 as described above. Thereby, a degree of freedom of arrangement of the second motor 61 and the controller 7 is increased. Also in such a case, the hose member 310 has flexibility that allows to be bent freely to certain extent, like the hose member 300 as described above, so that a degree of freedom of arrangement of a waterproof case(s) is increased. Furthermore, it is possible to ensure watertightness without applying a force to a waterproof case(s).

Furthermore, a harness 303 (see FIG. 11) is inserted through the communication holes 301, 302, so as to pass through these communication holes 301, 302. The harness 303 connects a motor(s) (the first motor 51 and the second motor 61) and the controller 7 electrically.

In such a configuration, in a case where the harness 303 is used in order to connect the motors 51, 61 and the controller 7 electrically, no dedicated hole for passing the harness 303 therethrough is needed. Thereby, it is possible to complete electrical connection of the motors 51, 61 and the controller 7 inside the first waterproof cases 200a, 200b and the second waterproof case 201, so that it is possible to improve a waterproof property thereof.

Furthermore, as illustrated in FIG. 10, in a case where the first motor case 200a and the second motor case 200b that are first waterproof cases house the first motor 51 and the second motor 61 separately, for example, the first motor case 200a that houses the first motor 51 among such first waterproof cases may be communicated with an external space of the bathroom unit 1000 (see FIG. 1).

In such a configuration, it is possible to arrange the first motor 51 for temperature control for a mixed hot and cold water where dew condensation is readily caused near a cold water at a low temperature because a hot water at a high temperature and such a cold water at a low temperature flow thereinto more than the second motor 61 for flow rate control, closer to a part that is communicated with an external space of the bathroom unit 1000 such as a wall of the bathroom unit 1000. Thereby, it is possible to reduce or prevent occurrence of dew condensation effectively.

As illustrated in FIG. 11 and FIG. 12, the controller case 201 that is a second waterproof case has a harness hole 305 where a plurality of harnesses 304 are inserted therethrough. The plurality of harnesses 304 electrically connect each of a plurality of electromagnetic valves that switch flow channels where a hot or cold water flows therethrough and the controller 7. The plurality of harnesses 304 are configured to be bundled by a binding member 306. The binding member 306 is, for example, a cabtyre that covers the plurality of harnesses 304 with a rubber, etc.

Furthermore, the harness hole 35 where the plurality of harnesses 304 are inserted therethrough includes a sealing member 307. In a state where the harnesses 304 are inserted through the harness hole 35, a gap between the harness hole 35 and the harnesses 304 are sealed by the sealing member 307 so as to be watertight. The sealing member 307 is, for example, a grommet.

In such a configuration, the plurality of harnesses 304 are bundled by a binding member (a cabtyre) 306 and inserted through the harness hole 305, so that it is possible to reduce a route where a water flows to the controller 7. Furthermore, although a large harness hole 305 is needed in a case where the plurality of harnesses 304 are bundled, the harness hole 305 is closed by the sealing member (a grommet) 307, so that it is possible to reduce or prevent intruding of a water into an inside(s) of a waterproof case(s) through a harness(es) 304 even in such a case.

As illustrated in FIG. 13, the faucet main body 3 further includes a cover member 400. The cover member 400 is a soft member. The cover member 400 covers a first waterproof case(s) (the first motor case 200a and the second motor case 200b) and a second waterproof case (the controller case 201), for example from a front side thereof.

In such a configuration, it is possible to reduce or prevent shifting of a relative position of the first waterproof cases 200a, 200b and the second waterproof case 201 that is caused by, for example, a worker that contacts a waterproof case(s), at a time of construction and a time of maintenance, etc., and is not allowed to ensure a waterproof property thereof. Herein, the cover member 400 is soft, so that it is possible to reduce or prevent gripping of the cover member 400 by a worker more effectively.

Furthermore, the cover member 400 may be provided with, for example, a display label 401 for a worker for construction. It is preferable to provide the display label 401 at a prominent position such as a front surface and/or an upper surface of the cover member 400. For example, a message and/or an illustration for attracting attention of a worker so as to prevent shifting of a position(s) of a waterproof case(s) is/are displayed on the display label 401.

An aspect of an embodiment aims to provide a faucet device that is capable of reducing or preventing occurrence of dew condensation inside a waterproof case that houses a motor and a controller and is capable of reducing or preventing a size increase of a faucet main body.

A faucet device according to an aspect of an embodiment is a faucet device including a water discharge part that discharges a hot or cold water, and a faucet main body that is arranged inside a bathroom and supplies a hot or cold water to the water discharge part, wherein the faucet main body includes a flow-rate/temperature control part that executes flow rate control and temperature control for a hot or cold water that is discharged from the water discharge part, a motor that drives the flow-rate/temperature control part, a controller that controls driving of the motor, a first waterproof case that houses the motor and isolates the motor from an internal space of the bathroom, and a second waterproof case that houses the controller and isolates the controller from an internal space of the bathroom, and the first waterproof case and the second waterproof case are communicated with an external space of the bathroom.

In such a configuration, a first waterproof case and a second waterproof case are communicated with an external space of a bathroom (for example, a space behind a wall of a bathroom), so that an air outside such a bathroom flows into such a first waterproof case and a second waterproof case and an air flows from such a first waterproof case and a second waterproof case to an outside of such a bathroom. An air outside a bathroom flows into or from a first waterproof case and a second waterproof case, so that it is possible to cause such a first waterproof case and a second waterproof case to execute so-called “breathing”. Thus, a first waterproof case and a second waterproof case execute “breathing”, so that it is possible to cause a temperature inside such a first waterproof case and a second waterproof case to be identical to a temperature outside a bathroom. Thereby, it is possible to reduce or prevent occurrence of dew condensation inside a first waterproof case and a second waterproof case. Furthermore, a motor is covered by a first waterproof case and a controller is covered by a second waterproof case, that is, such a motor and such a controller are covered by such waterproof cases separately, so that it is possible to minimize a size of each waterproof case. Thereby, it is possible to reduce or prevent a size increase of a faucet main body.

Furthermore, in the faucet device as described above, the first waterproof case and the second waterproof case are provided in such a manner that one of the waterproof cases is communicated with an external space of the bathroom and another of the waterproof cases is communicated with the one of the waterproof cases.

In such a configuration, one of a first waterproof case and a second waterproof case is communicated with an external space of a bathroom and another thereof is communicated with the one, so that such another of waterproof cases is indirectly communicated with such an external space of a bathroom through such one of waterproof cases. Thereby, it is possible to reduce a number of a hole(s) that is/are formed on a wall of a bathroom, etc., in such a manner that a waterproof case is communicated with an external space of such a bathroom, so that it is possible to increase a degree of freedom of arrangement of a motor and a controller. Thereby, it is possible to reduce or prevent a size increase of a faucet main body. Furthermore, in a case where cross sections of holes that are formed on a wall of a bathroom, etc., are identical, an efficiency of air ventilation is increased for a single large hole rather than for a plurality of small holes, so that it is possible to reduce or prevent occurrence of dew condensation effectively.

Furthermore, the faucet device as described above includes a harness that connects the motor and the controller, wherein the harness passes through a communication hole for communicating between the first waterproof case and the second waterproof case.

In such a configuration, in a case where a harness is used in order to connect a motor and a controller electrically, no dedicated hole for passing such a harness therethrough is needed. Thereby, it is possible to complete electrical connection of a motor and a controller inside a first waterproof case and a second waterproof case, so that a waterproof property thereof is improved.

Furthermore, in the faucet device as described above, the motor has a first motor for temperature control for a hot or cold water and a second motor for flow rate control for a hot or cold water, the first waterproof case houses the first motor and the second water separately, the second waterproof case is communicated with an external space of the bathroom, and the first motor is arranged closer to a part that is communicated with an external space of the bathroom than the second motor.

In such a configuration, even in a case where a first waterproof case that houses a motor, among such a first waterproof case and a second waterproof case, is indirectly communicated with an external space of a bathroom, it is possible to arrange a first motor for temperature control for a hot or cold water that causes dew condensation more readily than a second motor for flow rate control, close to a part that is communicated with such an external space of a bathroom, such as a wall of such a bathroom. Thereby, it is possible to reduce or prevent occurrence of dew condensation effectively. Furthermore, replacement of a first motor is also facilitated.

Furthermore, in the faucet device as described above, the motor has a first motor for temperature control for a hot or cold water and a second motor for flow rate control for a hot or cold water, the first waterproof case includes a first motor case that houses the first motor and a second motor case that houses the second motor, and the first motor case is communicated with an external space of the bathroom.

In such a configuration, it is possible to arrange a first motor for temperature control for a hot or cold water that causes dew condensation more readily than a second motor for flow rate control, close to a part that is communicated with an external space of a bathroom, such as a wall of such a bathroom. Thereby, it is possible to reduce or prevent occurrence of dew condensation effectively.

Furthermore, in the faucet device as described above, the first waterproof case and the second waterproof case are provided in such a manner that one of the waterproof cases is communicated with an external space of the bathroom and another of the waterproof cases is communicated with the one of the waterproof cases, and the one of the waterproof cases is communicated with an external space of the bathroom through a hose member.

In such a configuration, a waterproof case that is communicated with an external space of a bathroom, among a first waterproof case and a second waterproof case, is communicated with such an external space of a bathroom through a hose member, so that a degree of freedom of arrangement of a motor and a controller is increased. In particular, a hose member has flexibility that allows to be bent freely to certain extent, so that it is possible to increase a degree of freedom of arrangement of a waterproof case(s). Furthermore, a hose member has flexibility, so that it is possible to ensure watertightness without applying a force to a waterproof case(s).

Furthermore, the faucet device as described above includes a plurality of electromagnetic valves that switch between flow channels where a hot or cold water flows therethrough, and a plurality of harnesses that connect each of the plurality of electromagnetic valves and the controller, wherein the second waterproof case has a harness hole where the harnesses are inserted therethrough, the plurality of harnesses are configured to be bundled by a binding member and to be inserted through the harness hole, and the harness hole includes a sealing member that seals a gap between the harness hole and the harnesses to be watertight in a state where the harnesses are inserted therethrough.

In such a configuration, a plurality of harnesses are bundled by a binding member (a cabtyre) and are inserted through a harness hole, so that it is possible to reduce a route where a water flows to a controller. Furthermore, although a large harness hole is needed in a case where a plurality of harnesses are bundled, a harness hole is closed by a sealing member (a grommet) even in such a case, so that it is possible to reduce or prevent intruding of a water into an inside(s) of a waterproof case(s) through such a harness(es).

Furthermore, the faucet device as described above includes a cover member that covers the first waterproof case and the second waterproof case.

In such a configuration, it is possible to reduce or prevent shifting of a relative position of a first waterproof case and a second waterproof case that is caused by, for example, a worker that contacts a waterproof case(s), at a time of construction and a time of maintenance, etc., and is not allowed to ensure a waterproof property thereof. Herein, a cover member is soft, so that it is possible to reduce or prevent gripping of a cover member by a worker more effectively.

For a faucet device according to an aspect of an embodiment, it is possible to reduce or prevent occurrence of dew condensation inside a waterproof case that houses a motor and a controller and to reduce or prevent a size increase of a faucet main body.

### APPENDIX

(1) A faucet device, including:
a water discharge part that discharges a hot or cold water; and
a faucet main body that is arranged inside a bathroom and supplies a hot or cold water to the water discharge part, wherein
the faucet main body includes:
a flow-rate/temperature control part that executes flow rate control and temperature control for a hot or cold water that is discharged from the water discharge part;
a motor that drives the flow-rate/temperature control part;
a controller that controls driving of the motor;
a first waterproof case that houses the motor and isolates the motor from an internal space of the bathroom; and
a second waterproof case that houses the controller and isolates the controller from an internal space of the bathroom, and
the first waterproof case and the second waterproof case are communicated with an external space of the bathroom.
(2) The faucet device according to (1), wherein
the first waterproof case and the second waterproof case are provided in such a manner that one of the waterproof cases is communicated with an external space of the bathroom and another of the waterproof cases is communicated with the one of the waterproof cases.
(3) The faucet device according to (2), including
a harness that connects the motor and the controller, wherein
the harness passes through a communication hole for communicating between the first waterproof case and the second waterproof case.
(4) The faucet device according to (2) or (3), wherein
the motor has a first motor for temperature control for a hot or cold water and a second motor for flow rate control for a hot or cold water,
the first waterproof case houses the first motor and the second water separately,
the second waterproof case is communicated with an external space of the bathroom, and
the first motor is arranged closer to a part that is communicated with an external space of the bathroom than the second motor.
(5) The faucet device according to (2) or (3), wherein
the motor has a first motor for temperature control for a hot or cold water and a second motor for flow rate control for a hot or cold water,
the first waterproof case includes a first motor case that houses the first motor and a second motor case that houses the second motor, and
the first motor case is communicated with an external space of the bathroom.
(6) The faucet device according to any one of (1) to (5), wherein
the first waterproof case and the second waterproof case are provided in such a manner that one of the waterproof cases is communicated with an external space of the bathroom and another of the waterproof cases is communicated with the one of the waterproof cases, and
the one of the waterproof cases is communicated with an external space of the bathroom through a hose member.
(7) The faucet device according to any one of (1) to (6), including:
a plurality of electromagnetic valves that switch between flow channels where a hot or cold water flows therethrough; and
a plurality of harnesses that connect each of the plurality of electromagnetic valves and the controller, wherein
the second waterproof case has a harness hole where the harnesses are inserted therethrough,
the plurality of harnesses are configured to be bundled by a binding member and to be inserted through the harness hole, and
the harness hole includes a sealing member that seals a gap between the harness hole and the harnesses to be watertight in a state where the harnesses are inserted therethrough.
(8) The faucet device according to any one of (1) to (7), including
a cover member that covers the first waterproof case and the second waterproof case.

It is possible for a person(s) skilled in the art to readily derive an additional effect(s) and/or variation(s). Hence, a broader aspect(s) of the present invention is/are not limited to a specific detail(s) and a representative embodiment(s) as illustrated and described above. Therefore, various modifications are possible without departing from the spirit or scope of a general inventive concept that is defined by the appended claim(s) and an equivalent(s) thereof.

What is claimed is:

1. A faucet device, comprising:
a water discharge part that discharges a hot or cold water; and
a faucet main body that is arranged inside a bathroom and supplies a hot or cold water to the water discharge part, wherein
the faucet main body includes:
a flow-rate/temperature control part that executes flow rate control and temperature control for a hot or cold water that is discharged from the water discharge part;
a motor that drives the flow-rate/temperature control part;
a controller that controls driving of the motor;
a first waterproof case that houses the motor and isolates the motor from an internal space of the bathroom; and
a second waterproof case that houses the controller and isolates the controller from an internal space of the bathroom, and
the first waterproof case and the second waterproof case are communicated with an external space of the bathroom.

2. The faucet device according to claim 1, wherein
the first waterproof case and the second waterproof case are provided in such a manner that one of the waterproof cases is communicated with an external space of the bathroom and another of the waterproof cases is communicated with the one of the waterproof cases.

3. The faucet device according to claim 2, comprising
a harness that connects the motor and the controller, wherein
the harness passes through a communication hole that communicates between the first waterproof case and the second waterproof case.

4. The faucet device according to claim 2, wherein
the motor has a first motor for temperature control for a hot or cold water and a second motor for flow rate control for a hot or cold water,
the first waterproof case houses the first motor and the second water separately,
the second waterproof case is communicated with an external space of the bathroom, and
the first motor is arranged closer to a part that is communicated with an external space of the bathroom than the second motor.

5. The faucet device according to claim 2, wherein
the motor has a first motor for temperature control for a hot or cold water and a second motor for flow rate control for a hot or cold water,
the first waterproof case includes a first motor case that houses the first motor and a second motor case that houses the second motor, and
the first motor case is communicated with an external space of the bathroom.

6. The faucet device according to claim 1, wherein
the first waterproof case and the second waterproof case are provided in such a manner that one of the waterproof cases is communicated with an external space of the bathroom and another of the waterproof cases is communicated with the one of the waterproof cases, and
the one of the waterproof cases is communicated with an external space of the bathroom through a hose member.

7. The faucet device according to claim 1, comprising:
a plurality of electromagnetic valves that switch between flow channels where a hot or cold water flows therethrough; and
a plurality of harnesses that connect each of the plurality of electromagnetic valves and the controller, wherein
the second waterproof case has a harness hole where the harness is inserted therethrough,
the plurality of harnesses are configured to be bundled by a binding member and to be inserted through the harness hole, and
the harness hole includes a sealing member that seals a gap between the harness hole and the harness to be watertight in a state where the harness is inserted therethrough.

8. The faucet device according to claim 1, comprising
a cover member that covers the first waterproof case and the second waterproof case.
